(19) United States
(12) Patent Application Publication
(10) Pub. No.: US 2013/0237269 A1
(43) Pub. Date: Sep. 12, 2013

(54) ESTABLISHING A NEW WIRELESS LINK HOP

(71) Applicants: Karl-Magnus Moller, Gothenburg (SE); Jan-Olof Carlson, Moindal (SE)

(72) Inventors: Karl-Magnus Moller, Gothenburg (SE); Jan-Olof Carlson, Moindal (SE)

(73) Assignee: TELEFONAKTIEBOLAGET L M ERICSSON (PUBL), Stockholm (SE)

(21) Appl. No.: 13/885,800

(22) PCT Filed: Nov. 19, 2010
(86) PCT No.: PCT/EP2010/067824

§ 371 Date: May 16, 2013

(51) Int. Cl. H04W 16/00

(52) U.S. Cl. CPC H04W 16/00
USPC 455/509

(57) ABSTRACT

This disclosure is directed to a method for establish a new wireless link hop 10b comprising an operational wireless node 12a and a new wireless node 18a and a new wireless communication path 17a enabling communication between the operational node 12a and the new node 18a. The method performed in the new node 18a comprises the actions of receiving S1 a wireless installation signal transmitted from the operational node 12a, which installation signal comprises installation information enabling the new node 18a to establish the wireless path 17a so as to at least provide physical communication between the operational node 12a and the new node 18a, and the action of finding S2 the installation signal, and the action of obtaining S2 the installation information from the found installation signal, and the action of at least establishing S3 physical communication between the operational node 12a and the new node 18a via the wireless path 17a using the received installation information.

### TECHNICAL FIELD

The present invention relates to a method for establishing a new wireless link hop comprising a new wireless node. The present invention is also related to a wireless node configured to operatively implement the method.

### BACKGROUND

Wireless communication links are well known and widely used in various modern communication networks. Wireless communication links are e.g. often used for backhaul communication in modern telecommunication networks.

Typically, backhaul communication is communication that may occur between one or several radio access nodes or similar and a core network or core network node or similar in a wireless communication network, and/or between one or several radio access nodes and an access node controller or similar in a wireless communication network, and/or between an access node controller and a core network or core network node or similar of a wireless communication network, and/or between peer nodes in a core network or similar in an wireless communication network.

The radio access node may e.g. be a base station such as a eNodeB (eNB) or similar. The access node controller may e.g. be a Base Station Controller (BSC) or a Radio Network Controller (RNC) or similar. The core network may e.g. be the Evolved Packet Core (EPC) or similar. The wireless communication network may e.g. be the Evolved Packet System (EPS) or similar. The eNB, the BSC, the RNC, the EPC and the EPS and similar entities now mentioned are e.g. defined in the specifications provided by the 3^{rd} Generation Partnership Project (3GPP, see e.g. www.3gpp.org)

A known wireless communication link 10a is schematically illustrated in FIG. 1. The link 10 comprises two wireless nodes 12 and 14. The two nodes 12 and 14 are arranged to operatively communicate information between each other via a wireless communication path 16 in one direction only (unidirectional) or in both directions (bidirectional) as illustrated by the two arrow heads in FIG. 1. Various wireless communication links comprising two or more wireless nodes are well known to those skilled in the art and there is no need for a detailed description. An example of a known wireless node may e.g. be the MINI-LINK™ TN R4 provided by Ericsson (see e.g. www.ericsson.com).

The wireless communication link 10 may be a part of a larger wireless link network comprising several links of the same or similar type as the wireless communication link 10. The links of a wireless link network are typically connected to each other according to a suitable topology. The link 10 will then represent a single hop or leg of several hops or legs through which an information entity (e.g. a data packet) has to travel before it reaches its destination.

FIG. 2a is another schematic illustration of the wireless of the communication link hop 10 previously shown in FIG. 1. The wireless communication node 12 of the link hop 10 may be seen as a nucleus in any link topology comprising one or more wireless links, such as the wireless link 10. FIG. 2b is a schematic illustration of a wireless link network 200 comprising the wireless link 10 and a plurality of identical or similar links being operatively connected according to a ring topology. FIG. 2c is a schematic illustration of a wireless link network 300 comprising the link 10a and a plurality of identical or similar links being operatively connected according to a tree topology. Naturally, other topologies are clearly conceivable, e.g. a mesh topology, a star topology, a fully connected topology, a line topology or a buss topology or a combination of two or more of these topologies or similar.

The link network 200, 300 may comprise a network management function 210a, 310a respectively that is configured to operatively manage and/or control the activities of the wireless link network 200, 300 respectively and/or the wireless nodes therein e.g. the nodes 12 and 14. The network management function 210, 310 respectively may e.g. be connected to and/or implemented in any suitable part of the link network 200, 300 respectively. For example, the network management function 210, 310 respectively may be connected to and/or implemented in a wireless nodes or similar of the network 200, 300 respectively. A network management function may communicate with all the wireless nodes in the network being connected to each other according to a suitable topology as indicated above.

It is common that modern communication networks such as the 3GPP Evolved Packet System (EPS) or similar are based at least partly on wireless link networks such as the wireless link networks 200 or 300 or similar. Modern communication networks are often rapidly expanded, which thus may require an expansion of the wireless link network of the communication network in question.

Typically, a wireless link network or similar is expanded in that a new wireless node is installed and connected to an existing operational wireless node of the link network in question. For example, as can be seen in FIG. 2a, a new wireless node 18 may be installed and connected to the existing operational wireless node 12. Similarly, as can be seen in FIGS. 2b and 2c respectively, the link network 200 or 300 may be expanded such that a new wireless node 18 is installed and connected to the existing operational wireless node 12 or similar of the link network 200 or 300 respectively. A new transmission path 17 will then be established enabling the nodes 12 and 18 to operatively communicate information between each in one direction only (unidirectional) or in both directions (bidirectional) in the same or similar manner as described above for transmission path 17. The two wireless nodes 12 and 18 will then form a new wireless link hop of the same or similar kind as the known wireless link hop 10 described above with reference to FIG. 1.

However, with the introduction of packet based transport techniques in wireless links, the number of configuration parameters needed to setup a wireless link hop has exploded. The type of parameters range from e.g. Quality of Service (QoS) settings such as priority mapping and queue lengths to link configuration settings (channel etc) etc. etc.

Typically, when installing a new wireless link hop, a service technician carries with him an installation order comprising the parameter settings or similar printed out on paper and/or stored in his/hers computer or similar. When configuring the wireless link hop these settings are typically manually entered at each wireless node of the new link hop, or at least at the new wireless node of the new link hop. The configuration may e.g. be done by means of a local configuration tool of some sort. Other solutions may use a pre-configuration of the wireless link and its wireless nodes and/or a configuration at one or both wireless node by means of USB memory or similar.

However if the parameter settings or similar are wrong or corrupted and/or if the parameter settings or similar at one wireless node is misaligned with the parameter settings or similar at the other wireless node of the new link hop, then trouble shooting might be time consuming and difficult. For example, the trouble shooting may require repeated and time consuming travelling between the nodes of the new link hop.

### SUMMARY

In view of the above there seems to be a need for improving the installation of new wireless nodes in a wireless link network.

At least one improvement and/or advantage has been accomplished according to a first embodiment of the present solution directed to a method for establish a new wireless link hop comprising an operational wireless node and a new wireless node and a new wireless communication path enabling communication between the operational node and the new node. The method may be performed in the new node 18a and comprise the actions of receiving a wireless installation signal transmitted from the operational node, which installation signal comprises installation information enabling the new node to establish the wireless path so as to at least provide physical communication between the operational node and the new node, and the actions of finding the installation signal, and the actions of obtaining the installation information from the found installation signal, and the actions of at least establishing physical communication between the operational node and the new node via the wireless path using the received installation information . . . .

At least one improvement and/or advantage has been accomplished according to a second embodiment of the present solution directed to a wireless link hop comprising a new wireless node and an operational wireless node. The operational node is configured to operatively transmit a wireless installation signal comprising installation information enabling the new node to establish a wireless path so as to at least provide physical communication between the operational node and the new node. The new node is configured to operatively receive the wireless installation signal transmitted from the operational node, and to operatively find the installation signal, and to operatively obtain the installation information from the found installation signal, and to operatively at least establish physical communication between the operational node and the new node via the wireless path using the received installation information.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

It should also be emphasised that the actions preformed in the exemplifying methods described and/or claimed herein must not necessarily be executed in the order in which they appear. Moreover, embodiments of the exemplifying methods described and/or claimed herein may comprise fewer steps or additional steps without departing from the scope of the present invention.

### BRIEF DESCRIPTION OF THE DRAWINGS

FIG. 1 is a schematic illustration of a wireless communication link hop 10 comprising two wireless nodes 12 and 14 communicating via a wireless communication path 16,

FIG. 2a is another schematic illustration of the wireless node 12 of the communication link 10 in FIG. 1,

FIG. 2b is a schematic illustration of a wireless link network 200 comprising the link hop 10 and a plurality of identical or similar link hops being operatively connected according to a ring topology,

FIG. 2c is a schematic illustration of another wireless link network 300 comprising the link hop 10 and a plurality of identical or similar link hops being operatively connected according to a tree topology,

FIG. 3 is a schematic illustration of an expansion of an existing operational link hop 10a creating a new wireless link hop 10b comprising an operational wireless node 12b and a new wireless node 18a,

FIG. 4a is a schematic illustration of the new wireless node 18a according to an embodiment of the present solution,

FIG. 4b is a schematic illustration of the operational wireless node 12a according to an embodiment of the present solution,

FIG. 5 is a schematic flowchart illustrating an exemplifying method according to an embodiment of the present invention,

FIG. 6 is a schematic sequence diagram illustrating exemplifying methods according to embodiments of the present invention.

### DETAILED DESCRIPTION

### Structure of Embodiments

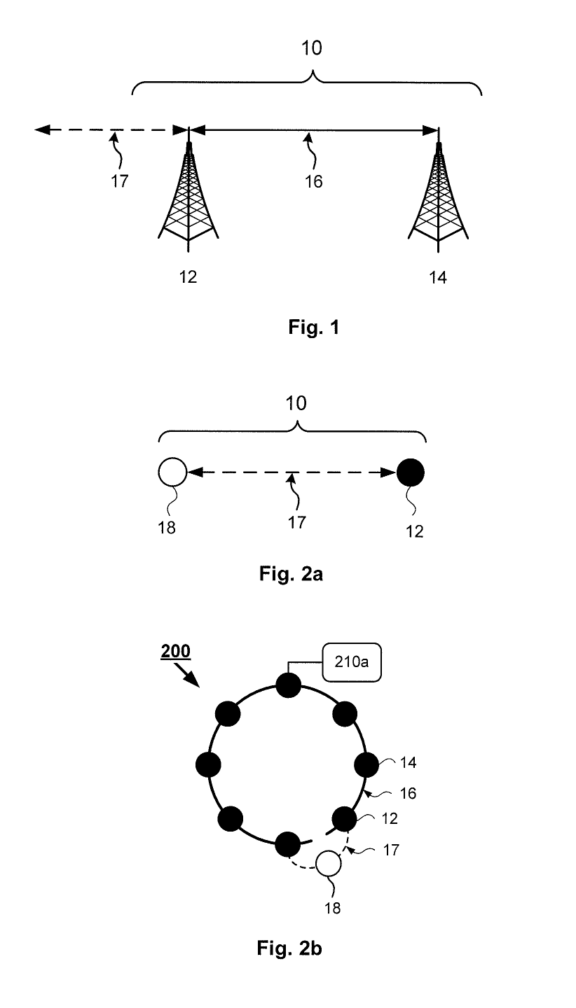

FIG. 3 shows a schematic illustration of an exemplifying wireless link network 100 according to an embodiment of the present solution. The wireless link network 100 may in its simplest form comprise a single operational wireless node 12a. However, the wireless link network 100 shown in FIG. 3 comprises one existing operational wireless link hop 10a that is to be expanded by a new wireless link hop 10b. The existing link hop 10a may comprise two wireless nodes 12a and 14a configured to operatively communicate information between each other via a wireless communication path 16a. The link hop 10a may be substantially identical to the link hop 10 previously described with reference to FIG. 1. Thus, the nodes 12a and 14a may be substantially identical to the known nodes 12 and 14 respectively. However, node 12a and node 14a differ from the known node 12 and node 14 respectively in that the node 12a and node 14a respectively are modified according to embodiments of the present solution as will be further elaborated below.

Before proceeding it should be emphasised that the wireless link network 100 may comprise a plurality of wireless link hops such as the operational link hop 10a or similar arranged according to a suitable topology or similar.

The attention is now directed to the new wireless link hop 10b schematically shown in FIG. 3. The new wireless link hop 10b has been added as an expansion of the existing wireless link hop 10a mentioned above.

The new wireless link hop 10b comprises the operational wireless node 12a mentioned above and a new wireless node 18a. The operational node 12a is configured to operatively transmit a wireless installation signal comprising installation information enabling the new node 18a to establish a new wireless communication path 17a so as to at least provide physical communication between the new node 18a and the operational node 12a. The new node 18a is configured to operatively find and obtain the installation signal. The new node 18a is configured to operatively at least establish physical communication between the new node 18a and the operational node 12a via the wireless path 17a using the received installation information.

It is preferred that the new wireless link hop 10b is a Line of Sight (LOS) link. Generally, a LOS link uses electromagnetic radiation wave propagation including light emissions that is allowed to travel substantially undisturbed in a straight line. Typically, LOS links use highly directional antennas. The directional antennas are then typically arranged such that the antenna lobe of a first antenna (e.g. at node 12a) points at a second antenna (e.g. a node 18a), and such the antenna lobe of the second antenna points at the first antenna. The lobe of the antennas may e.g. extend less than 10°, or less than 5°, or less than 3° in the vertical and the horizontal direction, or at least in the horizontal direction. The concept of LOS may be thought of as the ability of a human located at a receiving antenna to visually see the transmitting antenna. It is also preferred that the wireless link hop 10b is a fixed link hop. Thus, the wireless nodes 12a and 18a are preferably fixed and aligned with respect to each other and they are preferably not configured to be moved or transported.

The wireless nodes 12a and 18a of the wireless link hop 10b are arranged to operatively communicate information between each other via the new wireless communication path 17a, in one direction only (unidirectional) or in both directions (bidirectional) as illustrated by the two arrow heads in FIG. 3. The information may e.g. be communicated via the transmission path 17a by means of a microwave signal, e.g. utilizing microwaves above 1 GHz, or above 6 GHz or above 30 GHz, or above 50 GHz including suitable forms of light. Any suitable modulation scheme or similar may be used for conveying information between the wireless nodes 12a, 18a via the wireless transmission path 17a, e.g. modulations schemes such as Amplitude Modulation (AM), Single Sideband (SSB), Quadrature Amplitude Modulation (QAM), Frequency Modulation (FM), Phase Modulation or similar, and/or modulation schemes such as Frequency Shift Keying (FSK), Amplitude Shift Keying (ASK), Phase Shift Keying (PSK), Time Division Multiplexing (TDM), Frequency Division Multiplexing (FDM) or similar, and/or spread spectrum modulation such as various code modulation schemes or similar. Various combinations of the modulation schemes now mentioned may also be conceivable.

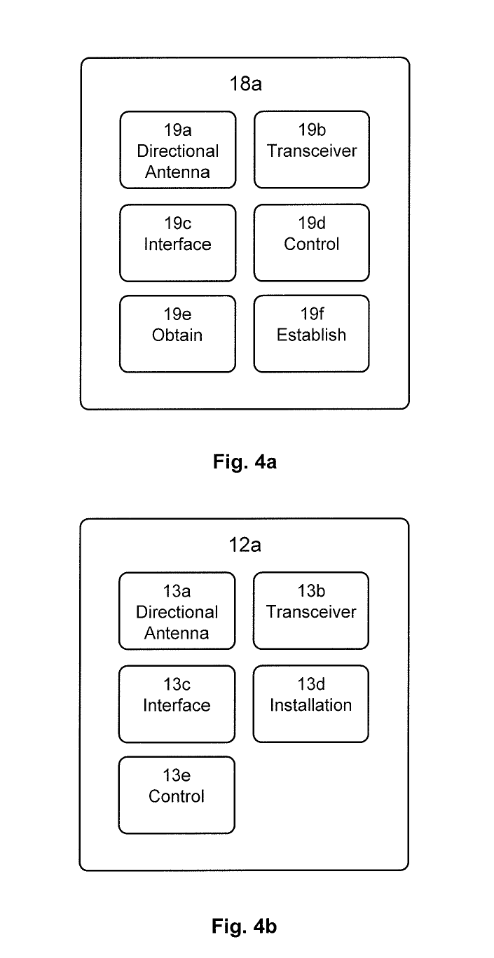

FIG. 4a is a schematic illustration of the new wireless node 18a according to an embodiment of the present solution. The new node 18a may comprise a directional antenna unit 19a and a transceiver unit 19b which are configured to operatively receive and/or transmit information from and/or to the operational wireless node 12a or similar via the wireless path 17a. The antenna unit 19a and a transceiver unit 19b are particularly configured to operatively receive the wireless installation signal transmitted by the operational node 12a. The node 18a may also comprise a local interface unit 19c configured to operatively communicate information between the node 18a and a first equipment 32 connected to the node 18a, e.g. via a local communication link 32 as indicated in FIG. 3. The local communication link 23 may e.g. be a wired communication network, e.g. such as the Ethernet or similar, e.g. using copper or optical fiber for the communication. The node 18a may also comprise an obtaining unit 19e that is configured to operatively find the wireless installation signal transmitted by the operational node 12a and to obtain information comprised by the wireless installation signal as will be further described later. In addition, the node 18a may comprise an establishing unit 19f that is configured to operatively establish communication with the operational node 12a via the wireless path 17a as will be described later. The node 18a may also comprise a control unit 19d that is configured to operatively manage and/or control the activities of the antenna unit 19a, the transceiver unit 19b, the interface unit 19c, the obtaining unit 19e and the establishing unit 19f.

FIG. 4b is a schematic illustration of the existing operational wireless node 12a according to an embodiment of the present solution. The operational wireless node 12a may be identical to or substantially identical to the new wireless node 18a described above. Thus, the operational node 12a may at least comprise a directional antenna unit 13a and a transceiver unit 13b in the same or similar manner as node 18a. Node 12a may also comprise a local interface unit 13c configured to operatively communicate information between node 18a and a second equipment 42 connected to node 12a as indicated in FIG. 3. The second equipment 42 may e.g. be directly or substantially directly connected to node 12a, or connected via one or more networks, e.g. comprising a wireless link network comprising additional wireless nodes, e.g. such as node 14a mentioned above. In addition, node 12a may comprise an installation unit 13d that is configured to operatively manage the transmission of the wireless installation signal and the installation information comprised by the installation signal as will be elaborated in more detail later. The management performed by the installation unit 13d may e.g. comprise the actions of obtaining, receiving and/or selecting information indicative of the appropriate properties for the wireless installation signal (e.g. frequency and/or modulation etc) and/or the appropriate installation information to be carried by the installation signal. Node 12a may also comprise a control unit 13e that is configured to operatively manage and/or control the activities of said units 13a, 13b, 13c and 13d. The attention is now directed to the first equipment 32 mention above in connection with the new wireless node 18a in FIGS. 3 and 4a. The first equipment 32 may e.g. be a radio base station, e.g. a radio base station in a cellular telecommunication network, e.g. such as a 3GPP eNodeB or similar. Alternatively, the first equipment 32 may be a network node or similar, e.g. such as a server or a router or similar. Alternatively, the first equipment 32 may be a core node (CN) in a communication network or similar. The core node may e.g. be a 3GPP core node, e.g. such as a Base Station Controller (BSC), a Radio Network Controller (RNC), a Serving GPRS Node (SGSN) or a Serving Gateway (SGW) or similar.

The description of the first equipment 32 made above applies mutatis mutandis to the second equipment 42 mention above in connection with the operational node 12a in FIGS. 3 and 4b. Thus, the second equipment 42 may be a radio base station or similar communicating with the first equipment 32 via the wireless nodes 12a and 18a. The second equipment 42 may e.g. be a radio base station in a cellular telecommunication network, e.g. such as a 3GPP eNodeB or similar. Indeed, both equipments 32 and 42 may e.g. be eNodeBs that communicate via an X2 interface that is fully or at least partly implemented by the wireless nodes 12a and 18a as described herein. Alternatively, the second equipment 42 may be a network node or similar e.g. such as a server or a router or similar. Alternatively, the second equipment 42 may be a core node (CN) in a communication network 40 or similar. The communication network 40 may e.g. be a cellular communication network. The core node may e.g. be a 3GPP core node, e.g. such as a Base Station Controller (BSC), a Radio Network Controller (RNC), a Serving GPRS Node (SGSN) or a Serving Gateway (SGW) or similar.

From the discussion above it can be concluded that it is particularly preferred that node 18a—using units 19a, 19b, 19c, 19d, 19e and/or 19f or similar—is configured to operatively convey information from the first equipment 32 to the second equipment 42 via node 12a. Similarly, it is particularly preferred that node 18a—using units 19a, 19b, 19c, 19d and/or 19e or similar—is configured to operatively receive information from the second equipment 42 via node 12a and to convey this information further to the first equipment 32. It is also preferred that node 12a—using units 13a, 13b, 13c, 13d and/or 13e or similar—is configured to operatively convey information between the first equipment 32 and the second equipment 42 via node 18a in the same or similar manner as now described for node 18a.

From the discussion above it can also be concluded that the new wireless link hop 10b may be a backhaul communication link hop, e.g. conveying communication between one or several radio access nodes or similar and a core network or core network node or similar in a wireless communication network, and/or between one or several radio access nodes and an access node controller or similar in a wireless communication network, and/or between an access node controller and a core network or core network node or similar of a wireless communication network, and/or between peer nodes in a core network or similar in an wireless communication network.

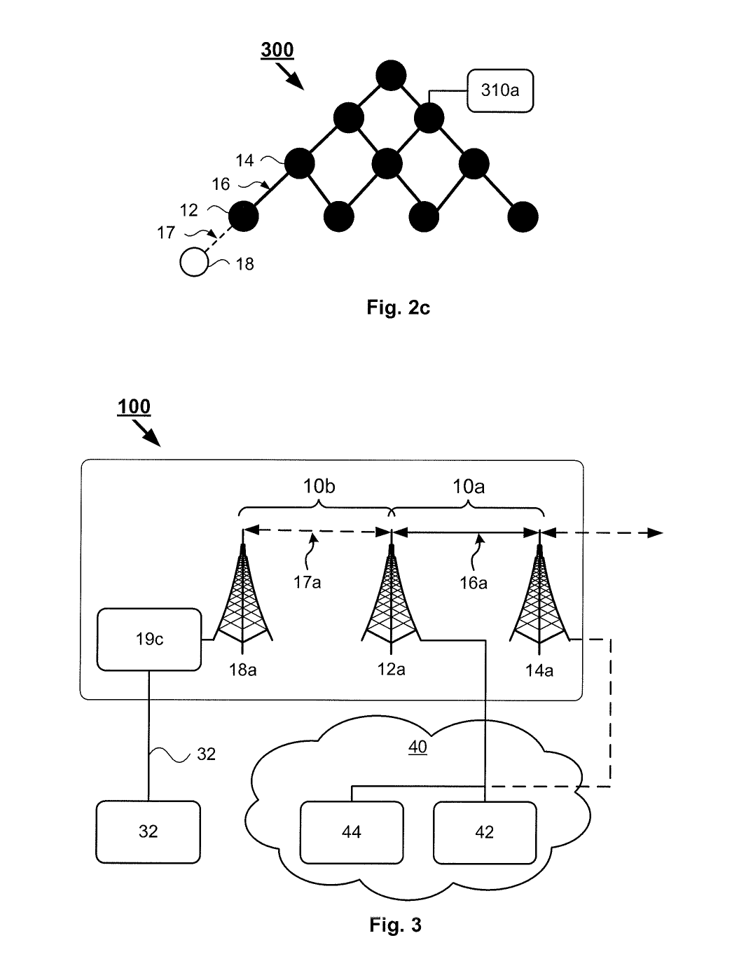

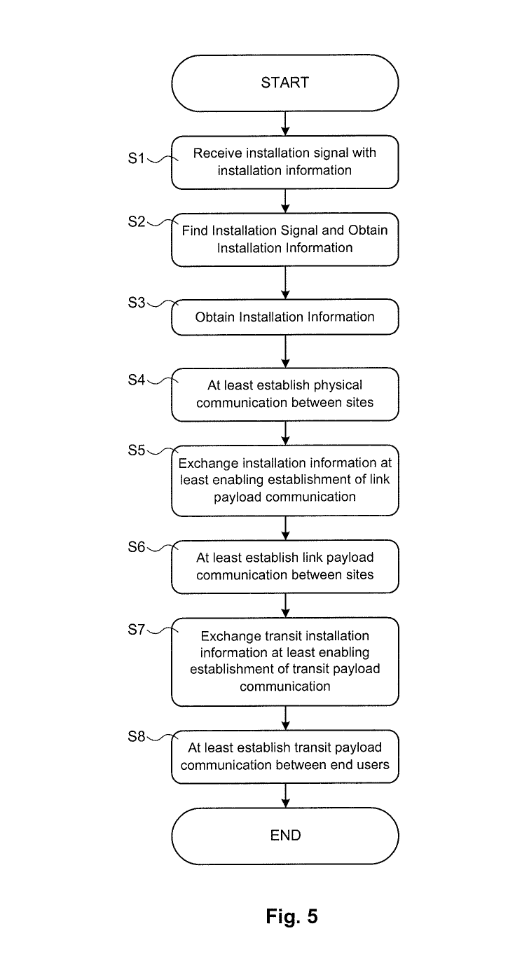

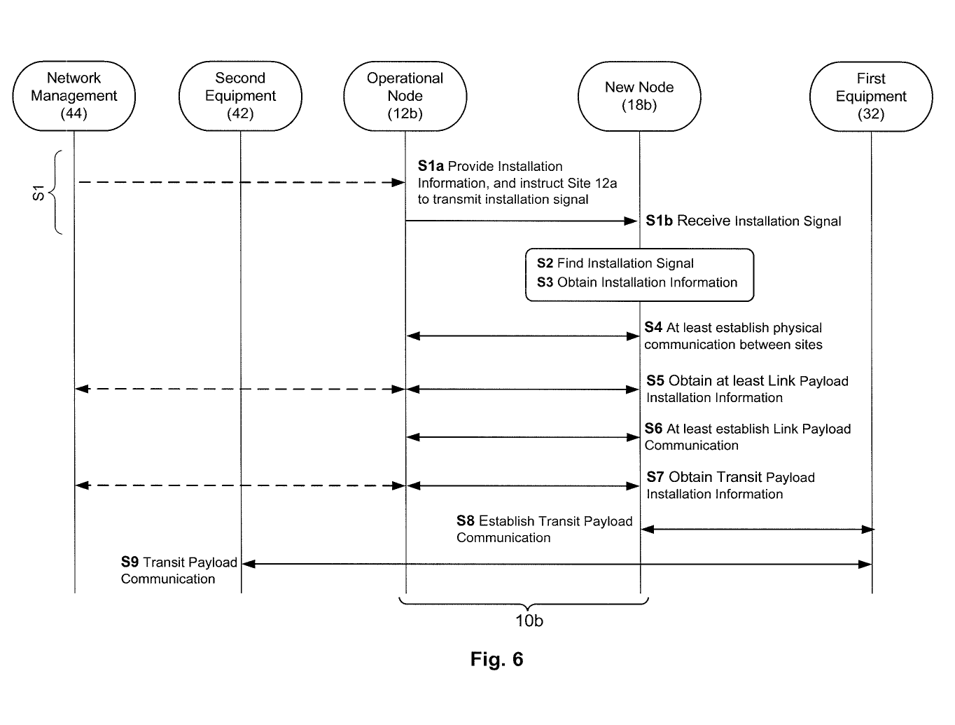

Before proceeding it should be clarified that, as can be seen in FIG. 3, the operational wireless node 12a may be connected to a network management function 44 configured to operatively manage and/or control activities of the operational wireless node 12a according to embodiments of the present solution. The network management function 44 may e.g. be a part of the wireless node 12a or the communication network 40 or similar. The network management function 44 may e.g. be an Operation and Maintenance (OAM) function or similar. The OAM may be a functional entity from which the network operator monitors and controls the wireless link network 100. The OAM may e.g. offer the network operator support for centralized, regional, and local operational and maintenance activities. The OAM may e.g. administrate the commercial operation related to such features as subscription, end terminals, charging and statistics, security management, network configuration, operation and performance management and/or maintenance tasks etc. The network management function 44 may communicate with all the wireless nodes 12a and 14a etc in the wireless link network 100, which nodes may be connected to each other according to a suitable topology as indicated in the background section with reference to FIGS. 2a-2c. It is preferred that the network management function 44 is configured to operatively provide the operational wireless node 12a with at least a part of the information comprised by the installation signal transmitted by node 12a to node 18a as will be described in more detail below reference to FIG. 5 and FIG. 6.

Before turning to FIG. 5 and FIG. 6 and a discussion of the function of embodiments of the present solution something should be said about the wireless installation signal that is operatively transmitted by the operational wireless node 12a and operatively received by the new wireless node 18a. The wireless installation signal may comprise information indicating that the signal is in fact an installation signal. This may e.g. be accomplished by transmitting at a predetermined frequency and/or according to a predetermined modulation scheme or similar and/or according to a predetermined bit-pattern or similar and/or by transmitting a predetermined frame pattern and/or frame structure or similar. The frequency, the modulation scheme, the bit-pattern, the frame pattern and/or the frame structure or similar to expect may be known by the new node 18a. This enables the node 18a to find the installation signal and to obtain information comprised by the installation signal. Transmitted frames may e.g. comprise frame synchronisation information enabling the receiving new node 18a to perform frame synchronization—i.e. to identify incoming frame alignment signals, i.e. distinctive bit sequences (e.g. synchronization words) that are distinguished from data bits—permitting the data bits within the frames to be extracted for decoding by the new node 18a.

It is preferred that the installation signal comprises installation information. The installation information may comprise information that enables the new node 18a to establish the wireless path 17a between the operational node 12a and the new node 18a so as to at least provide physical communication between the nodes 12a and 18a.

To provide physical communication it may be sufficient if the installation information comprises information indicative of the radio parameters that the new node 18a shall use with respect to the operational node 12a during reception and/or transmission. The radio parameters may e.g. indicate the transmission and/or receiving frequency or frequencies to be used by the new node 18a. In addition, the radio parameters may e.g. indicate the modulation scheme or schemes to be used by the new node 18a during transmission and/or reception.

Physical communication in a very simple form may e.g. correspond to transmission and no transmission, i.e. similar to a Morse code communication.

Physical communication in a more advanced form may require that the installation information of the installation signal enables the new node 18a to establish communication with node 12a via the wireless path 17a at least according to layer 1 “Physical Layer” of the Open Systems Interconnection model (OSI-model) and possibly also according to layer 2 “Data Link” of the OSI-model.

The installation information may also enable the new node 18a to establish further communication with node 12a via the wireless path 17a, e.g. so as to enable payload communication (i.e. payload data) to be communicated or conveyed between node 12a and node 18a as will be elaborated further later under actions S1-S9. Payload communication is typically the data that is carried within a transmission unit, e.g. within a data packet or similar as is well known to those skilled in the art. Typically, the payload data does not include the overhead data of the transmission unit required to transport the transmission unit to its destination. Typically, payload data is the data that is delivered to the end user at the destination indicated by the overhead data of the transmission unit in question.

Establishing payload communication between nodes 12a and 18a may e.g. require that the installation information of the installation signal enables the new node 18a to establish link payload communication between node 12a and node 18a via the wireless path 17a. A link payload communication may e.g. be established according to layer 2 “Data Link” of the OSI-model or similar or according to the first layer “Link Layer” of the Internet Protocol Suit (i.e. the TCP/IP suit) or similar. It is preferred that the link payload communication is communicated between node 12a and node 18a via the wireless path 17a such that the link payload communication is terminated in node 12a and/or in node 18a. Thus, it is preferred that the link payload communication is not conveyed transparently or substantially transparently by the new wireless hop 10b.

In addition, establishing payload communication between nodes 12a and 18a may e.g. require that the installation information of the installation signal enables the new node 18a to establish transit payload communication that is conveyed via node 12a and node 18a and the wireless path 17a according to all or substantially all layers of the OSI-model or the TCP/IP suit. For example, the installation information may enable node 18a to establish communication with node 12a via the wireless path 17a according to layer 3 “Network Layer” of the OSI-model and preferably also at least according to layer 4 “Transport Layer” of the OSI-model. Similarly, the installation information may enable node 18a to establish communication with node 12a via the wireless path 17a according the second layer “Internet” of the TCP/IP suit and preferably also at least according to the third layer “Transport” or even the fourth layer “Application” of the TCP/IP suit. It is preferred that the transit payload communication is conveyed between node 12a and node 18a via the wireless path 17a of the new wireless hop 10b on behalf of end-users, e.g. end-users such as the first equipment 32 and the second equipment 42 previously described with reference to FIG. 3. Thus, the transit payload communication is preferably not terminated in node 12a or in node 18a. On the contrary, the transit payload communication is preferably transparently or substantially transparently conveyed by the new wireless hop 10b between the first equipment 32 connected to the new node 18a and the second equipment 42 connected to the operational node 12a.

It should be clarified that the installation information discussed above may be delivered in at a single action (e.g. at the beginning of the installation of the new node 18a).

Alternatively, the installation information may be delivered at one or more subsequent actions (e.g. after one or more requests from the new node 18a).

### Function of Embodiments

The attention is now directed to the flowchart in FIG. 5 and the sequence diagram in FIG. 6 illustrating the operation of exemplifying embodiments of the present solution.

### Action S1

In this action S1 it is presumed that the existing operational wireless node 12a transmits a wireless installation signal comprising installation information. The installation signal is received by the new wireless node 18a. This presumes that the directional antenna 19a of the new node 18a is directed towards the operational node 12a to enabling the new node 18a to receive the installation signal transmitted by the operational node 12a. Naturally, this also presumes that the new node 18a has been powered up and that the directional antenna unit 19a and the transceiver unit 19b are operational.

Before proceeding it should be emphasised that the mere reception of the transmitted installation signal does not necessarily imply that the installation signal is actually found by the new node 18a. For example, the new node 18a may continue scanning a frequency band within which the installation signal is transmitted even if the installation signal was temporarily received.

It is preferred that the installation information comprises by the received installation signal at least enables the new wireless node 18a to establish physical communication between the operational node 12a and the new node 18a via the wireless path 17a.

However, in other embodiments of the present solution the operational node 12a may already in action S1 transmit a wireless installation signal with installation information that enables the new wireless node 18a to establish payload communication between node 12a and node 18a as will be elaborated later under actions S4-S9.

The installation information comprised by the transmitted installation signal may be stored in the operational node 12a itself before transmission. For example, the installation information may be pre-stored, preloaded or preconfigured or similar in the operational node 12a. Alternatively, the installation information or at least parts thereof may be provided by the network management function 44 to the operational node 12a according to a sub-action S1a or similar of action S1.

It is preferred that the operational node 12a is set to an installation mode in action S1. It is preferred that the installation mode causes node 12a to transmit the wireless installation signal comprising the installation information. The operational node 12a may be set to installation mode locally, e.g. by a technician visiting the operational node 12a. Alternatively, the operational node 12a may be set to installation mode remotely, e.g. by the network management function 44 sending installation mode instructions to node 12a. The installation mode is preferably temporary, e.g. only lasting until sufficient communication abilities have been established between node 12a and node 18a via the wireless path 17a, e.g. until a sufficient physical communication or sufficient payload communication has been established as previously described. The operational node 12a may be taken out of installation mode locally by a technician or remotely by the network management function 44 or similar. Alternatively, operational node 12a may terminate the installation mode itself, e.g. when the operational node 12a detects that sufficient physical communication or sufficient payload communication has been established.

### Action S2

In this action S2 the new wireless node 18a finds the wireless installation signal transmitted by the operational node 12a and received by the new node 18a in action S1.

As already indicated under action S1, a reception of the transmitted installation signal does not mean that the installation signal is found by the new node 18a. For example, node 18a may continue scanning a frequency band within which the installation signal is transmitted even if the installation signal was temporarily received.

It is preferred that the new wireless node 18a remains in a receiving state while the wireless installation signal is received and found. In other words, it is preferred that the new node 18a does not transmit during action S1 and S2.

Wireless nodes in a link hop such as node 12a and node 18a in the new link hop 10a are typically not allowed to transmit outside a particular frequency band or similar. Thus, it is preferred that the installation information indicates an allowed frequency band or similar to be used by the new node 18a for transmissions. This enables the new node 18 to establish communication with node 12a via the wireless path 17 while only transmitting within the allowed transmitting frequency band or similar as indicated by the installation information. If the opposite situation occurs, i.e. if the new node 18a tries to establish communication with the operational node 12a without knowing the allowed frequency band there is an evident risk that the new node 18a will transmit outside the allowed frequency band while trying to retrieve installation information and/or while establishing communication with node 12a via the wireless path 17a. This is typically not allowed in wireless link networks and/or wireless link hops, particularly not in publicly deployed link networks and/or link hops.

Before proceeding it should be emphasised that a frequency band typically comprise many frequencies, e.g. from X to Y MHz, or from X to Y GHz or similar. However, nothing precludes that a frequency band only comprises a single frequency or only a few frequencies or similar, e.g. X MHz, or X MHz and Y MHz, or X GHz, or X GHz and Y GHz or similar. Similarly, a frequency band may comprise several sub-bands. A frequency band may e.g. comprise a first sub-band from X to Y MHz and a second sub-band from P to S MHz etc.

The attention is now directed to the finding of the transmitted installation signal by the new node 18a. A person skilled in the art having the benefit of this disclosure realises that the new node 18a may find the transmitted installation signal in many different ways. For example, the new node 18a may find the transmitted installation signal by receiving all signals transmitted on a predetermined frequency or similar or within a predetermined frequency band, e.g. by scanning the predetermined frequency band.

As already explained above, to facilitate a finding of the installation signal it is preferred that the installation signal comprises information indicating that the installation signal is in fact an installation signal. This makes it possible for the new node 18a to decode the received installation signal and to recognise the installation signal as an installation signal. Thus, this makes it possible for the new node 18a to distinguish the installation signal from other signals that may be received by the new node 18a. The other signals may e.g. be transmitted by other wireless nodes or similar or even by the operational node 12a.

The properties of the transmitted installation signal enabling the new node 18a to find the installation signal is preferably known to the new node 18a. For example, information indicating the properties of the installation signal may be stored in the new node 18a, e.g. be pre-stored, preloaded or preconfigured or similar in the new node 18a. The stored information may e.g. indicate the radio parameters or similar of the transmitted installation, e.g. indicate the frequency and/or modulation scheme or similar and/or bit-pattern or similar and/or frame pattern and/or frame structure or similar that is used by the installation signal to indicate that the installation signal is in fact an installation signal.

### Action S3

In this action S3 the new wireless node 18a obtains the installation information comprised by the wireless installation signal received in action S1 and found in action S2 by the new wireless node 18a.

It is preferred that the new node 18a remains in a receiving state while the installation information comprised by the installation signal is received, found and obtained. In other words, it is preferred that the new node 18a does not transmit during action S1, S2 and S3. This is preferred for the reasons as given above when discussing action S2.

The attention is now directed to the obtaining of the installation information from the received installation signal by the new node 18a. A person skilled in the art having the benefit of this disclosure realises that the new node 18a may obtain the installation information from the received installation signal in many different ways. For example, the transmitted and received installation signal may comprise frames and frame synchronisation information enabling the receiving new node 18a to perform frame synchronization—i.e. to identify incoming frame alignment signals, i.e. distinctive bit sequences (e.g. synchronization words) that are distinguished from data bits. This permits the new node 18a to extract and decode the data bits and/or bytes or similar representing the installation information within the frames transmitted by the installation signal.

### Action S4

In this action S4 the new wireless node 18a communicates with the operational node 12a so as to at least establish physical communication with the operational node 12a via the wireless path 17a by using the installation information obtained from the installation signal in action S3.

As already indicated above, physical communication may be established in a very simple form may e.g. correspond to transmission and no transmission. In that case it may be sufficient if the installation information comprises information indicative of the radio parameters that the new node 18a shall operatively use during reception and/or transmission. The new node 18a will then establish physical communication with the operational node 12a by simply transmit and/or receive according to the indicated radio parameters, e.g. transmit and/or receive at a frequency or frequencies or similar indicated by the parameters, and possibly also according to a modulation scheme or schemes or similar indicated by the parameters.

More advanced physical communication may require that the installation information enables the new node 18a to establish communication with the operational node 12a via the wireless path 17a according to layer 1 “Physical Layer” of the OSI-model and possibly also according to layer 2 “Data Link” of the 051-model or similar. The new node 18a will then establish physical communication with the operational node 12a according to layer 1 of the OSI-model or similar, and possibly also according to layer 2 of the OSI-model or similar as indicated by the installation information. Various suitable methods for establishing layer 1 and layer 2 of the OSI-model or similar between various wireless link nodes are well known to those skilled in the art. In addition, the precise manner of establishing layer 1 and layer 2 of the OSI-model or similar between the wireless link nodes 12a and 18a is not crucial for embodiments of the present solution. Thus, there is no need for a detailed description of the precise manner of establishing layer 1 and layer 2 of the OSI-model or similar between the wireless link nodes 12a and 18a.

As already indicated when discussing action S1, in other embodiments of the present solution the operational node 12a may transmit a wireless installation signal comprising installation information that enables the new wireless node 18a to also establish payload communication between node 12a and node 18a. In that case it is preferred that payload communication is also established in this action S4, e.g. as is elaborated below under actions S6 and S8.

### Action S5

In this action S5 the new wireless node 18a may obtain further installation information from the operational node 12a via the wireless communication path 17a established in action S4 (at least physical communication).

This action S5 may be performed to the extent the installation information obtained in the third action S3 was not sufficient to enable and cause the new node 18a to at least establish link payload communication with the operational node 12a via the wireless communication path 17a. As explained above, it is preferred that link payload communication is communicated between node 12a and node 18a via the wireless path 17a such that the link payload communication is terminated in node 12a and/or in node 18a.

In this action S5 it is preferred that the new node 18a sends a request to node 12a requesting such payload installation information that at least enables the new node 18a to establish link payload communication with node 12a via the wireless path 17a. It is also preferred that the new node 18a receives a response from node 12a comprising such payload installation information that at least enables the new node 18a to establish link payload communication with node 12a via the wireless path 17a.

The payload installation information provided by the response may be stored in the operational node 12a itself. For example, the payload installation information may be pre-stored, preloaded or preconfigured or similar in the operational node 12a.

Alternatively, the payload installation information may be provided by the network management function 44 to the operational node 12a.

In other embodiments of the present solution the new node 18a may also request and receive transit payload installation information from the operational node 12a in this action S5, which transit payload installation information enables the new wireless node 18a to establish transit payload communication between node 12a and node 18a as will be described below under action S8.

### Action S6

In this action S6 the new wireless node 18a may at least establish link payload communication with the operational node 12a via the wireless communication path 17a according to the installation information obtained in action S5.

This action S6 may be performed to the extent installation information is obtained in action S5.

It is preferred that the installation information enables the new node 18a to at least establish link payload communication with the operational node 12a via the wireless path 17a such that the payload communication is terminated in the operational node 12a and/or in the new node 18a. This may e.g. be accomplished by installation information comprising the unique Media Access Control address (i.e. the MAC-address) or similar of the two nodes 12a and 18a respectively enabling the new node 18a to establish terminating payload communication with the operational node 12a via the wireless path 17a. This may also be done by installation information comprising information that enables the new node 18a to establish communication with the operational node 12a according to layer 2 “Data Link” and possibly also layer 3 “Network” of the OSI-model or similar, or according to the first layer “Link” layer of the TCP/IP suit or similar. The new node 18a will then establish link payload communication with the operational node 12a according to the installation information.

Establishing layer 2 and layer 3 of the OSI-model or the “Link” layer of the TCP/IP suit between various wireless link nodes are well known to those skilled in the art. In addition, the precise manner of establishing terminating payload communication between the wireless link nodes 12a and 18a is not crucial for embodiments of the present solution. Thus, there is no need for a detailed description of the precise manner of establishing terminating payload communication between the wireless link nodes 12a and 18a.

In some embodiments of the present solution the operational node 12a may transmit a wireless installation signal comprising installation information that enables the new wireless node 18a to also establish transit payload communication between node 12a and node 18a. In that case it is preferred that transit payload communication is also established in this action S6, e.g. as is elaborated below under action S8.

### Action S7

In this action S7 the new wireless node 18a may obtain further installation information with the operational node 12a via the wireless communication path 17a established in action S4 (at least physically communication) and in action S6 (at least link payload communication).

This action S7 may be performed to the extent the installation information obtained in the action S3 and action S5 was not sufficient to enable and cause the new node 18a to at least establish transit payload communication with the operational node 12a via the wireless communication path 17a. As has already been explained above, it is preferred that transit payload communication is conveyed between node 12a and node 18a via the wireless path 17a of the new wireless hop 10b on behalf of end-users, e.g. end-users such as the first equipment 32 and the second equipment 42 previously described with reference to FIG. 3. Thus, transit payload communication is preferably not terminated in node 12a or in node 18a.

In this action S7 it is preferred that the new node 18a sends a request to node 12a requesting such payload installation information that enables the new node 18a to establish transit payload communication with node 12a via the wireless path 17a. It is also preferred that the new node 18a receives a response from node 12a comprising such payload installation information that enables the new node 18a to establish transit payload communication with node 12a via the wireless path 17a.

The payload installation information provided by the response may be stored in the operational node 12a itself. For example, the payload installation information may be pre-stored, preloaded or preconfigured or similar in the operational node 12a. Alternatively, the payload installation information may be provided by the network management function 44 to the operational node 12a.

### Action S8

In this action S8 the new wireless node 18a may establish transit payload communication with the operational node 12a via the wireless communication path 17a according to the installation information obtained in action S7.

This action S8 may be performed to the extent installation information is obtained in action S7.

It is preferred that the installation information enables the new node 18a to establish transit payload communication with the operational node 12a via the wireless path 17a such that the payload communication can be conveyed between node 12a and node 18a via the wireless path 17a on behalf of end-users. This may e.g. be accomplished by installation information comprising information that enables the new node 18a to establish communication with the operational node 12a via the wireless path 17a according to layer 3 “Network” and possibly layer 4 “Transport” or even higher layers of the OSI-model or similar, or according to the second layer “Internet” or possibly the third layer “Transport” or even higher layers of the TCP/IP suit or similar. The new node 18a will then establish link payload communication with the operational node 12a according to the installation information.

Establishing layer 3 and higher layers of the OSI-model or the “Network” layer or higher layers of the TCP/IP suit between various wireless link nodes are well known to those skilled in the art. In addition, the precise manner of establishing transit payload communication via the wireless link nodes 12a and 18a is not crucial for embodiments of the present solution. Thus, there is no need for a detailed description of the precise manner of establishing transit payload communication between the wireless link nodes 12a and 18a.

### Action S9

In this action S9 transit transit payload communication is operatively conveyed between node 12a and node 18a via the wireless path 17a of the new wireless hop 10b on behalf of end-users, e.g. end-users such as the first equipment 32 and the second equipment 42 previously described with reference to FIG. 3.

The embodiments indicated above may be summarized in the following manner:

One embodiment of the present solution is directed to a method for establish a new wireless link hop 10b. The new wireless link hop 10b comprises an operational wireless node 12a and a new wireless node 18a and a new wireless communication path 17a enabling communication between the operational node 12a and the new node 18a. The method may be performed in the new node 18a and it may comprise the actions of receiving S1 a wireless installation signal transmitted from the operational node. It is preferred that the installation signal comprises installation information enabling the new node to establish the wireless path so as to at least provide physical communication between the operational node 12a and the new node 18a. The method may also comprise the actions of finding S2 the installation signal, and obtaining S2 the installation information from the found installation signal, and at least establishing S3 physical communication between the operational node 12a and the new node 18a via the wireless path 17a using the received installation information.

It is preferred that the new node 18a remains in a receiving state during the receiving, finding and obtaining actions. As indicated above, no transmissions during the receiving, finding and obtaining actions ensures that transmissions are made only within the allowed frequency band once the new node 18a starts transmitting.

Establishing S3 of the physical communication via the wireless path 17a may comprise the action of establishing S3 a physical communication on a frequency band determined by the new node 18a based on the information obtained from the received installation signal.

Receiving the wireless installation signal may comprise the action of receiving signals within a predetermined frequency band.

Finding the installation signal may comprise the action of determine whether a received signal is an installation signal.

The method may comprise the actions of obtaining from the operational node 12a further installation information enabling the new node 18a to establish the wireless path 17a such that at least terminating payload communication can be conveyed between the operational node 12a and the new node 18a, and the actions of at least establishing terminating payload communication between the operational node and the new node 18a via the wireless path 17a.

The method may comprising the actions of obtaining from the operational node 12a further installation information enabling the new node 18a to establish the wireless path 17a such that transit payload communication can be conveyed between the operational node 12a and the new node 18a, and the actions of establishing transit payload communication between the operational node 12a and the new node 18a via the wireless path 17a.

The obtaining of further installation information form the operational node 12a may comprise the actions of sending a request to the operational node 12a requesting further installation information enabling the new node 18a to establish the wireless path 17a such that at least terminating payload communication can be conveyed between the operational node 12a and the new node 18a. The obtaining may also comprise the actions of receiving the requested installation information form the operational node 12a.

The request may comprises information indicative of the identity of the new node 18a and/or the identity of the first equipment 32 enabling the operational node 12a and/or the network management function 44 to select and transmit installation information that is particularly suited for the new node 18a and/or the first equipment 32.

The operational node 12a may be controlled by a network management function 44 transmitting to the operational node 12a at least a part of the physical properties of the installation signal and/or at least a part of the installation information to be transmitted by the operational node 12a to the new node 18a.

Another embodiment of the present solution is directed to a wireless link hop 10b comprising a new wireless node 18a and an operational wireless node 12a. The operational node 12a is configured to operatively transmit a wireless installation signal comprising installation information enabling the new node 18a to establish a wireless path 17a so as to at least provide physical communication between the operational node 12a and the new node 18a. The new node 18a is configured to operatively receive S1b the wireless installation signal transmitted from the operational node 12a. The new node 18a is configured to operatively find the installation signal. The new node 18a is configured to operatively obtain the installation information from the found installation signal. The new node 18a is configured to operatively at least establish physical communication between the operational node 12a and the new node 18a via the wireless path 17a using the received installation information.

The new node 18a may be configured to operatively remain in a receiving state during the receiving, finding and obtaining.

The new node 18a may be configured to operatively establish a physical communication with the operational node 12a via the wireless path 17a on a frequency band being determined by the new node 18a based on the information obtained from the received installation signal.

The new node 18a may be configured to operatively receive the wireless installation by receiving signals within a predetermined frequency band.

The new node 18a may be configured to operatively find the installation signal by determine whether a received signal is an installation signal.

The new node 18a may be configured to operatively obtain from the operational node 12a further installation information enabling the new node 18a to establish the wireless path 17a such that at least terminating payload communication can be conveyed between the operational node 12a and the new node 18a, and to operatively at least establish terminating payload communication between the operational node 12a and the new node 18a via the wireless path 17a.

The new node 18a may be configured to operatively obtain from the operational node 12a further installation information enabling the new node 18a to establish the wireless path 17a such that transit payload communication can be conveyed between the operational node 12a and the new node 18a, and to operatively establish transit payload communication between the operational node 12a and the new node 18a via the wireless path 17a.

The further installation information may be obtained form the operational node 12a by the new node 18a being configured to operatively send a request to the operational node 12a requesting further installation information enabling the new node 18a to establish the wireless path 17a such that at least terminating payload communication can be conveyed between the operational node 12a and the new node 18a, and to operatively receive the requested installation information form the operational node 12a.

The new node 18a may be configured to operatively send the request such that the request comprises information indicative of the identity of the new node 18a and/or the identity of the first equipment 32 enabling the operational node 12a and/or the network management function 44 to select and transmit installation information that is particularly suited for the new node 18a and/or the first equipment 32.

The present invention has now been described with reference to exemplifying embodiments. However, the invention is not limited to the embodiments described herein. On the contrary, the full extent of the invention is only determined by the scope of the appended claims.

1. A method for establish a new wireless link hop (10b) comprising an operational wireless node (12a) and a new wireless node (18a) and a new wireless communication path (17a) enabling communication between the operational node (12a) and the new node (18a),
wherein the method performed in the new node (18a) comprises the actions of:
receiving (S1) a wireless installation signal transmitted from the operational node (12a), which installation signal comprises installation information enabling the new node (18a) to establish the wireless path (17a) so as to at least provide physical communication between the operational node (12a) and the new node (18a),
finding (S2) the installation signal,
obtaining the installation information from the found installation signal,
at least establishing (S3) physical communication between the operational node (12a) and the new node (18a) via the wireless path (17a) using the received installation information.

2. A method according to claim 1, wherein the new node (18a) remains in a receiving state during the receiving, finding and obtaining.

3. A method according to claim 1, wherein establishing (S3) the physical communication via the wireless path (17a) comprises the action of establishing (S3) a physical communication on a frequency band determined by the new node (18a) based on the information obtained from the received installation signal.

4. A method according to any one of claim 1, 2 or 3, wherein:
receiving the wireless installation signal comprises the action of receiving signals within a predetermined frequency band.

5. A method according to any one of claim 1, 2, 3 or 4, wherein:
finding the installation signal comprises the action of determine whether a received signal is an installation signal.

6. A method according to any one of claim 1, 2, 3, 4 or 5, comprising the actions of:
obtaining (S4; S7) from the operational node (12a) further installation information enabling the new node (18a) to establish the wireless path (17a) such that at least terminating payload communication can be conveyed between the operational node (12a) and the new node (18a), and
at least establishing (S6; S8) terminating payload communication between the operational node (12a) and the new node (18a) via the wireless path (17a).

7. A method according to claim 6, comprising the actions of:
obtaining (S7) from the operational node (12a) further installation information enabling the new node (18a) to establish the wireless path (17a) such that transit payload communication can be conveyed between the operational node (12a) and the new node (18a),
establishing (S8) transit payload communication between the operational node (12a) and the new node (18a) via the wireless path (17a).

8. A method according to any one of claim 6 or 7, wherein the obtaining (S4; S7) of further installation information form the operational node (12a) comprises the actions of:
sending a request to the operational node (12a) requesting further installation information enabling the new node (18a) to establish the wireless path (17a) such that at least terminating payload communication can be conveyed between the operational node (12a) and the new node (18a),
receiving the requested installation information form the operational node (12a).

9. A method according to claim 8, wherein:
the request comprises information indicative of the identity of the new node (18a) and/or the identity of the first equipment (32) enabling the operational node (12a) and/or the network management function (44) to select and transmit installation information that is particularly suited for the new node (18a) and/or the first equipment (32).

10. A method according to any one of claim 1, 2, 3, 4, 5, 6, 7, 8 or 9, wherein the operational node (12a) is controlled by a network management function (44) transmitting to the operational node (12a) at least a part of the physical properties of the installation signal and/or at least a part of the installation information to be transmitted by the operational node (12a) to the new node (18a).

11. A wireless link hop (10b) comprising a new wireless node (18a) and an operational wireless node (12a),
wherein;
the operational node (12a) is configured to operatively transmit a wireless installation signal comprising installation information enabling the new node (18a) to establish a wireless path (17a) so as to at least provide physical communication between the operational node (12a) and the new node (18a),
the new node (18a) is configured to operatively receive (S1b) the wireless installation signal transmitted from the operational node (12a),
the new node (18a) is configured to operatively find (S2) the installation signal,
the new node (18a) is configured to operatively obtain the installation information from the found installation signal,
the new node (18a) is configured to operatively at least establish (S3) physical communication between the operational node (12a) and the new node (18a) via the wireless path (17a) using the received installation information.

12. The wireless link hop (10b) according claim 11, wherein:
the new node (18a) is configured to operatively remain in a receiving state during the receiving, finding and obtaining.

13. The wireless link hop (10b) according claim 11, wherein:
the new node (18a) is configured to operatively establish (S3) a physical communication with the operational node (12a) via the wireless path (17a) on a frequency band being determined by the new node (18a) based on the information obtained from the received installation signal.

14. The wireless link hop (10b) according any one of claim 11, 12 or 13, wherein:
the new node (18a) is configured to operatively receive the wireless installation by receiving signals within a predetermined frequency band.

15. The wireless link hop (10b) according to any one of claim 11, 12, 13 or 14 wherein:
the new node (18a) is configured to operatively find the installation signal by determine whether a received signal is an installation signal.

16. The wireless link hop (10b) according to any one of claim 11, 12, 13, 14 or 15, wherein the new node (18a) is configured to operatively:
obtain (S4; S7) from the operational node (12a) further installation information enabling the new node (18a) to establish the wireless path (17a) such that at least terminating payload communication can be conveyed between the operational node (12a) and the new node (18a), and
at least establish (S6; S8) terminating payload communication between the operational node (12a) and the new node (18a) via the wireless path (17a).

17. The wireless link hop (10b) according to claim 16, wherein the new node (18a) is configured to operatively:
obtain (S7) from the operational node (12a) further installation information enabling the new node (18a) to establish the wireless path (17a) such that transit payload communication can be conveyed between the operational node (12a) and the new node (18a),
establish (S8) transit payload communication between the operational node (12a) and the new node (18a) via the wireless path (17a).

18. The wireless link hop (10b) according to any one of claim 16 or 17, wherein the further installation information is obtained (S4; S7) form the operational node (12a) by the new node (18a) being configured to operatively
send a request to the operational node (12a) requesting further installation information enabling the new node (18a) to establish the wireless path (17a) such that at least terminating payload communication can be conveyed between the operational node (12a) and the new node (18a),
receive the requested installation information form the operational node (12a).

19. The wireless link hop (10b) according to claim 18, wherein the new node (18a) is configured to operatively:
send the request such that the request comprises information indicative of the identity of the new node (18a) and/or the identity of the first equipment (32) enabling the operational node (12a) and/or the network management function (44) to select and transmit installation information that is particularly suited for the new node (18a) and/or the first equipment (32).
